(19) United States
(12) Patent Application Publication
(10) Pub. No.: US 2013/0174992 A1
(43) Pub. Date: Jul. 11, 2013

(54) CLIP AND SHADE TO PROVIDE SHADE INSIDE A VEHICLE

(71) Applicant: Lior Biniamin HADDAD, Petach Tikva (IL)

(72) Inventor: Lior Biniamin HADDAD, Petach Tikva (IL)

(21) Appl. No.: 13/347,782

(22) Filed: Jan. 11, 2012

(51) Int. Cl. B60J 3/00

(52) U.S. Cl. 160/370.21; 160/405

(57) ABSTRACT

A system for shading a window of a motor vehicle. The system has a shade material, a first portion of the shade material is adapted to cover an area of the window, a second portion of the shade material is adapted to be located outside the window and a bent portion adapted to be bent over an edge of the window. The system further includes at least one clip with a first leg and a second leg. The first leg and the second leg are adapted to press on the shade material thereby frictionally attaching the shade material to the window with the first leg and the second leg.

### BACKGROUND

1. Technical Field

The present invention relates to a system and method for providing shade from sunlight inside a vehicle.

2. Description of Related Art

Numerous prior art references give examples of systems and methods to shade a side window of a vehicle.

U.S. Pat. No. 4,944,548 discloses a side window shade for automobiles which is formed from a panel having multiple sections connected by double folding joints. An upper edge of the panel is configured with a curvature corresponding to an automobile side window frame and includes multiple spaced notches which removably receives suction cup retainers for securing the panel to an automobile side window. The panel may be formed from a white corrugated cardboard material or may be at least partially formed from a tinted transparent material to allow visibility through the side window. The suction cup retainers each include a pair of pivotally connected jaw members and a spring which biases the jaw members to a closed position.

U.S. Pat. No. 7,748,433 discloses a support assembly for a collapsible automobile shade such as a pleated or folding screen which can be selectively moved between a collapsed position for storage and an open position for placement in a vehicle window. The support assembly has a lip, the lip has a generally inverted U shape that extends for the width of the clip. The lip is used to hang the support assembly onto an edge of the vehicle window.

U.S. Pat. No. 6,976,523 shows a foldable automobile shade for use in an automobile prevents sunlight from entering the automobile. The shade includes a storage accessory having a pocket or chamber and a pleated screen connected to the storage accessory near a bottom of the storage accessory and a closure which maintains the screen in its folded position. Mounting clips are provided to mount the shade to a vehicle's side window. The mounting clips have a generally C-shaped body which is sized and shaped to be snapped onto a shade frame member. A hook extends from a back of the mounting clips, the hook is sized and shaped to fit over the top edge of the vehicle side window.

U.S. Pat. No. 7,401,840 shows a window shade, stored on a storage roller mounted beneath a vehicle window opening. A trim panel has a slot through which the window shade may be unwound and raised to a use position shading the window. One or more hooks are attached to the window shade to engage with mating hook retainers at the top of the window opening to retain the window shade in its raised position. The lowered position of the window shade is established by the hook being engaged with a corresponding hook retainer on the trim panel. A finger grip is pivotally mounted on the upper end of the window shade so that the finger grip can have a predetermined pivotal position corresponding to the lowered position of the window shade and a different pivotal position when the window shade is in the raised position.

U.S. Pat. No. 6,682,121 shows a sun shade for use with and mounting to a side or rear automobile window includes a material configured to inhibit sunlight from passing through the material while allowing sufficient light to pass through the material such that a person can see through the material. The sun shade includes clips (hook-shaped clips) welded or bonded to the material. The clips are configured to fit over a top of a window, e.g., an automobile window without interfering with closing of the automobile window.

Prior art vehicle sun shades of which the art references cited above are representative have individually or collectively one or more disadvantages. Some prior art vehicle sun shades interfere with the normal action of the window. Some interfere with interaction with a person outside while the window is open. Others may have an excessive number of elements or permanent attachment between the shade and other elements. Prior art sunshades may break and are not easily repaired, reused or replaced.

Thus there is a need for and it would be advantageous to have a side window vehicle sun shade with a minimum number of elements, a sun shade which does not shade when the window is lowered allowing interaction with a person outside the vehicle and in which the elements are easily replaced if lost and of high reliability and repairability.

### BRIEF SUMMARY

According to an aspect of the present invention there is provided a system for shading a window of a motor vehicle. The system has a shade material, a first portion of the shade material is adapted to cover an area of the window, a second portion of the shade material is adapted to be located outside the window and a bent portion adapted to be bent over an edge of the window. The system further includes at least one clip with a first leg and a second leg. The first leg and the second leg are adapted to press on the shade material thereby frictionally attaching the shade material to the window with the first leg and the second leg. The first leg is typically longer than the second leg or the first leg is the same length as the second leg. The first leg includes a bend in a direction away from the window when installed on the window. The at least one clip includes at least two clips. The at least one clip may be one clip extended over a substantial portion of the edge of the window. The at least one clip is manufactured from spring steel.

According to an aspect of the present invention there is provided a method for shading a window of a motor vehicle using a shade material and a clip. With the window partially open, the shade material is folded over an edge of the window. A first portion of the shade material is located to be on the inside of the motor vehicle and a second portion of the shade material is located to be on the outside of the motor vehicle. A first leg of the clip is positioned in vicinity of the first portion and a second leg of the clip is positioned in vicinity of the second portion. A downward pressure on the clip is then applied, thereby providing a frictional clamping of the shade material to both the inside and outside of the window with the first leg and the second leg respectively. A winding up by raising the window, provides shade from the sun and a winding down by lowering the window removes the shade from the sun and gives a full view of the environment exterior to the vehicle. The winding down does not disturb the frictional clamping.

According to an aspect of the present invention there is provided a system for shading a window of a motor vehicle, the system has just a shade material and two clips each with a first leg and a second leg. The first leg and the second leg are adapted to press on the shade material folded over the top edge of the window, The clips frictionally attach the shade material to the window between the first leg and the second leg. The clips and the shade material are provided in a kit.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

The invention is herein described, by way of example only, with reference to the accompanying drawings, wherein:

FIG. 1 shows an isometric view of a vehicle according to an aspect of the present invention.

FIGS. 2a and 2b show an isometric view and a side view respectively of a clip in a non-deformed shape, according to an aspect of the present invention.

FIGS. 3a, 3b show before and after views of a clip and a shade material being applied to a window, according to an aspect of the present invention.

FIG. 3c which shows a method for providing shade to passengers seated in vehicle, according to an aspect of the present invention.

The foregoing and/or other aspects will become apparent from the following detailed description when considered in conjunction with the accompanying drawing figures.

### DETAILED DESCRIPTION

Reference will now be made in detail to aspects of the present invention, examples of which are illustrated in the accompanying drawings, wherein like reference numerals refer to the like elements throughout. The aspects are described below to explain the present invention by referring to the figures.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

By way of introduction, aspects of the present invention are directed to a shade material attachable and re-attachable to a window with a clip. The shade material is not permanently attached to the clip to avoid the shade material becoming detached from the clip. The clip has a size and shape which allows the window to be wound up and down without disturbing the attachment of the shade material to the window. The winding down of the window also brings down the shade material, which allows for the passengers in a vehicle to be observed by a police officer or parent through the open window. Use of the clip also avoids trapping fingers in the window since it is possible to just place the shade material between the window and the frame of the window, followed by winding the window up so as to trap the shade material in the frame of the window and trap at least one finger as well.

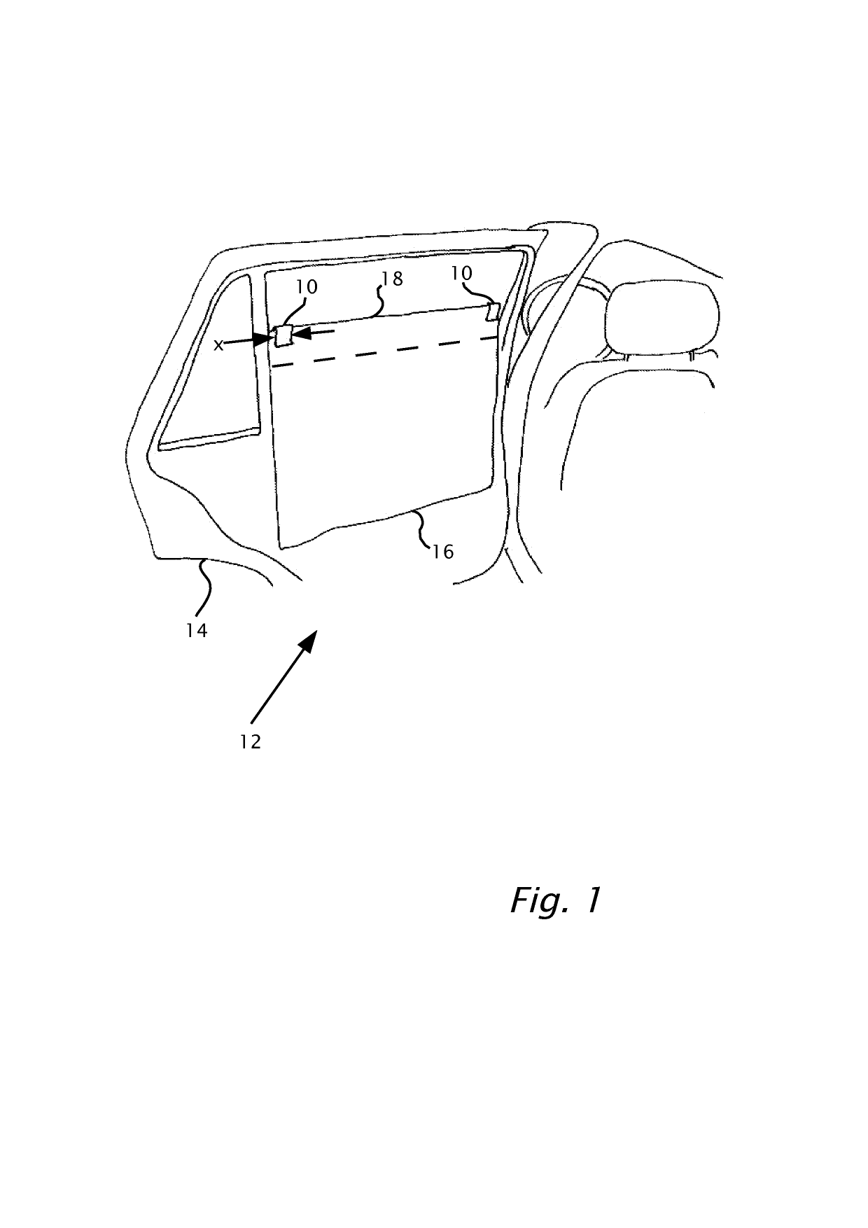

Reference is now made to FIG. 1 which shows an isometric view of a vehicle 12 according to an aspect of the present invention. The isometric view shows an open vehicle door 14 with a window 18 of door 14 partially open. A shade material 16 is shown folded over a horizontal edge of window 18. The larger portion of shade 16, when door 14 is closed, is located on the inside of vehicle 12. The smaller portion of shade 16, when door 14 is closed is located on the outside of vehicle 12. Shade 16 is preferably held frictionally onto window 18 using two or more clips 10 of width x. Alternatively, one clip 10 may be used where the width x of one clip 10 covers a substantial part the horizontal edge of window 18.

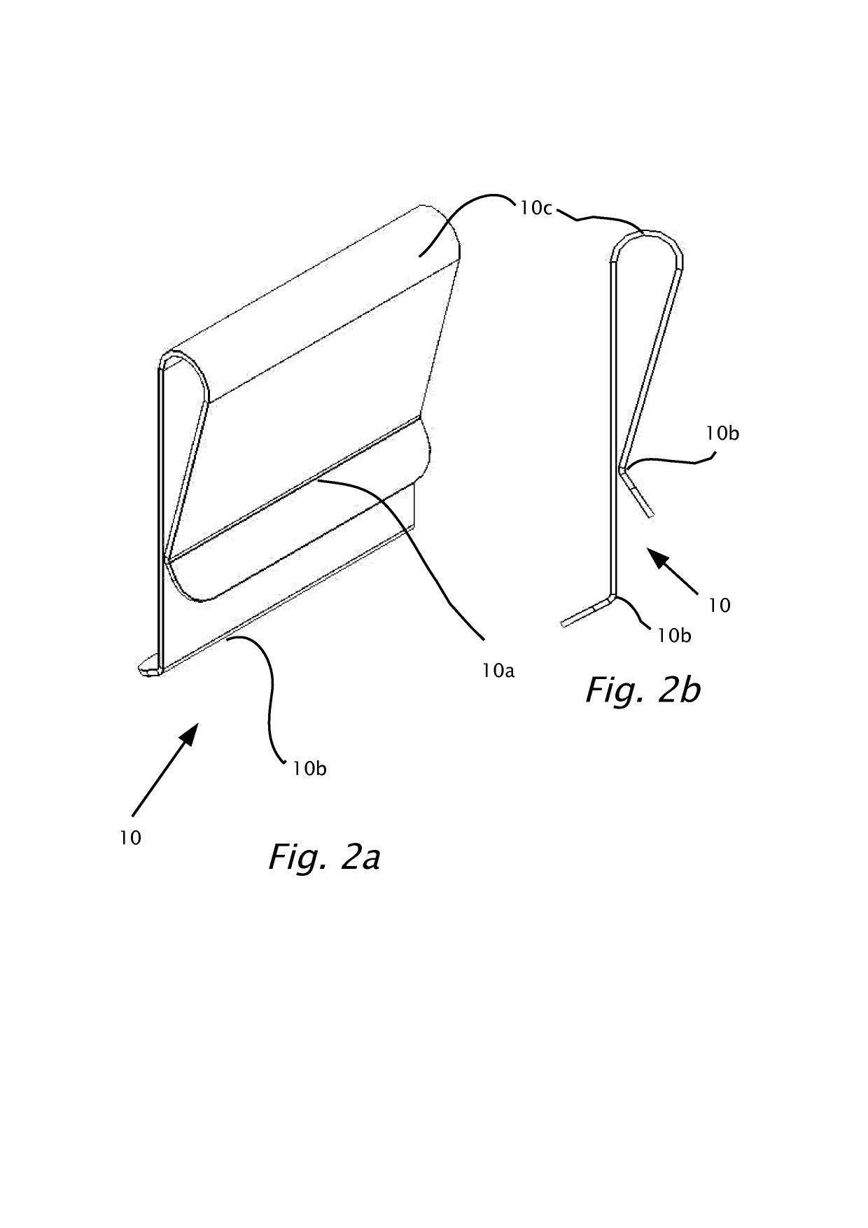

Reference is now made to FIGS. 2a and 2b which show an isometric view and a side view respectively of a clip 10 in a non-deformed shape, according to an aspect of the present invention. Clip 10 is typically made from spring steel and/or spring stainless steel. Clip 10 may be made from iron or iron alloys or plastic. Wall thickness of the clip is generally between 0.2 to 0.7 millimeter. Clip 10 has two legs with two ends attached to a curvature 10c, with the other two ends of the two legs having two bends 10a and 10b at or near the end of each leg. One leg of clip 10 is preferably longer than the other leg or both legs may be of equal length.

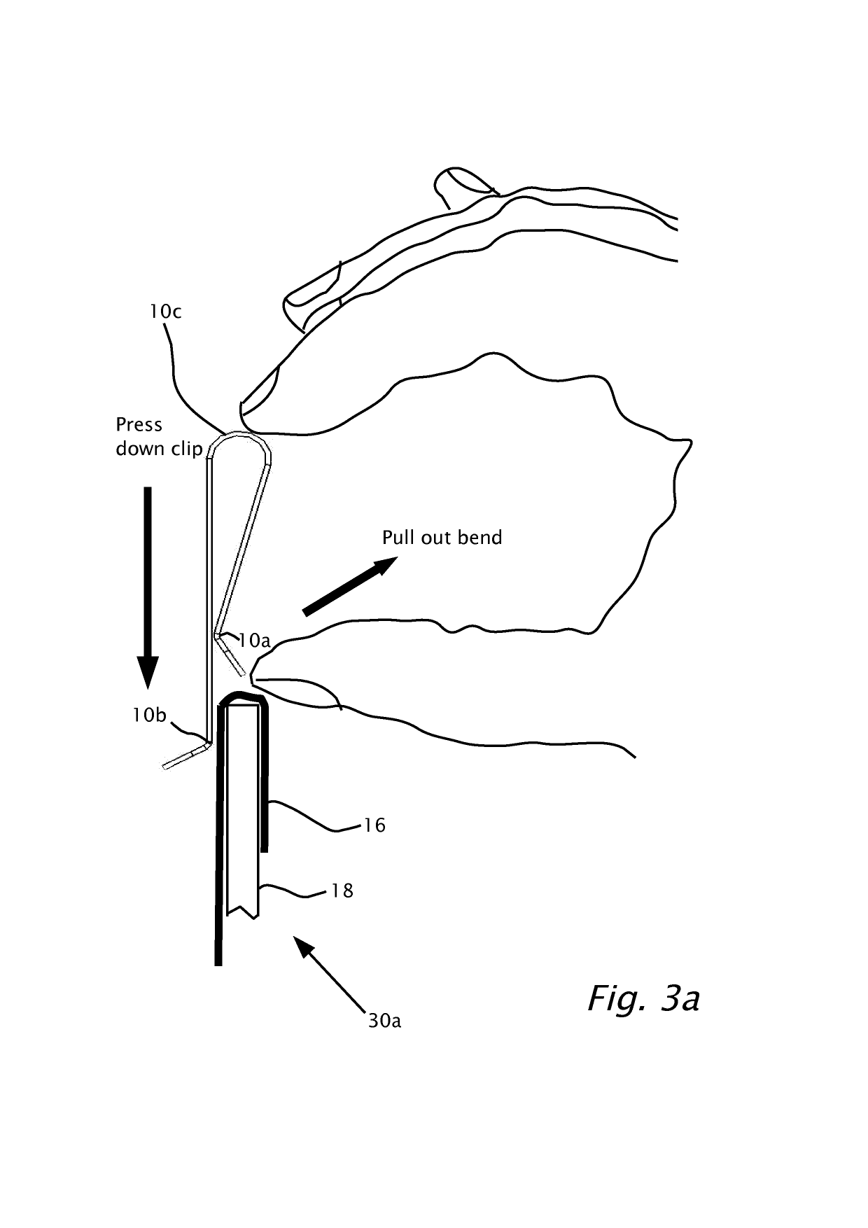

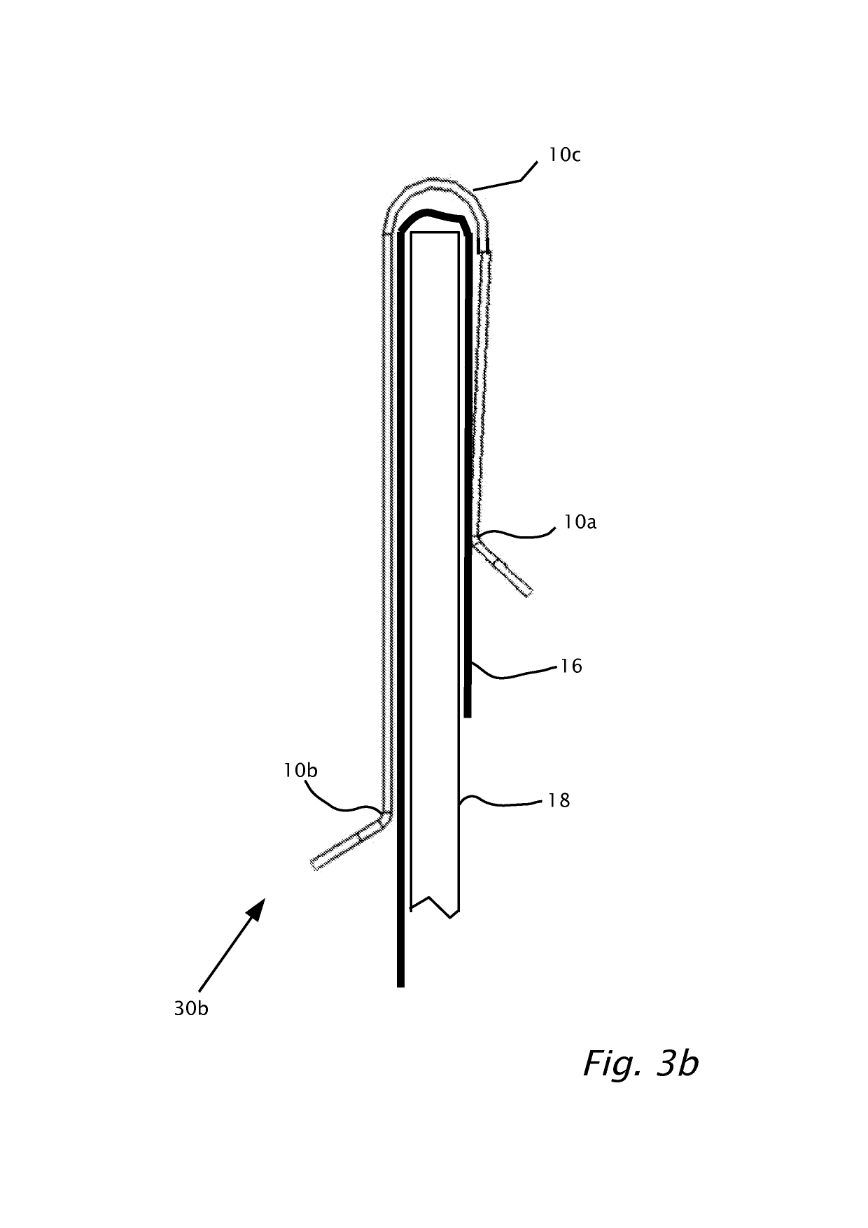

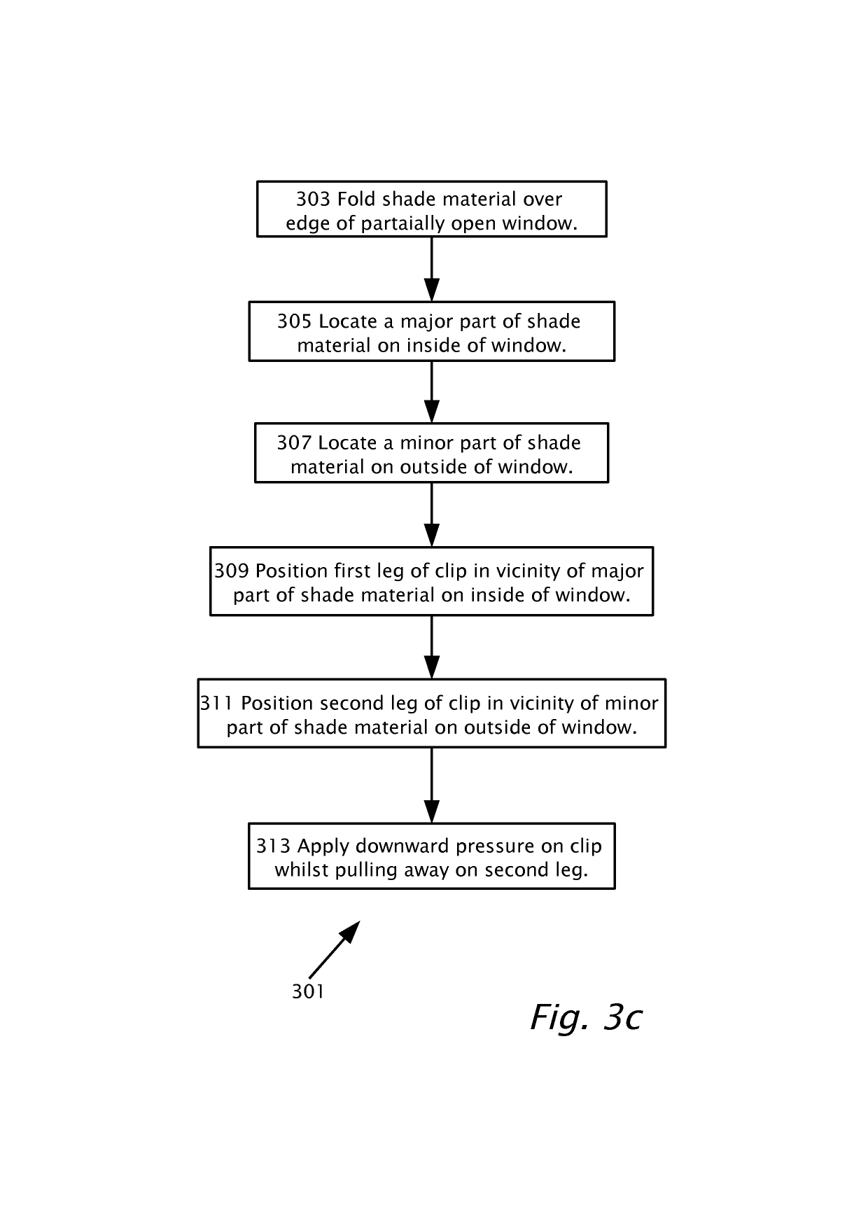

Reference is now made to FIGS. 3a, 3b which show before and after views of a clip 10 and shade material 16 being applied to a window 18 and to FIG. 3c which shows a method 301 for providing shade to passengers seated in vehicle 12, according to an aspect of the present invention. To provide shade to passengers in vehicle 12, window 18 is first partially opened and in step 303, shade material 16 is folded over an horizontal edge of window 18. Shade 16 is then positioned on window 18 such that a major part of shade 16 is located on the inside of vehicle 12 (step 305) and a minor part of shade 16 is located on the outside of vehicle 12 (step 307).

Referring now to FIG. 3a, clip 10 is held in between an index finger and a thumb. The index finger is located at a curvature 10c of clip 10. The curvature 10c of clip 10 provides a longer leg and a shorter leg of clip 10. The thumb is located at the end the shorter leg of clip 10 where bend 10a is. Bend 10a near the end of the shorter leg helps to place thumb over clip 10 over shade material 16 and the edge of window 18. In step 309 the longer leg of clip 10 which has a bend 10b (near the end of the longer leg) is located where a major part of shade 16 is located on the inside of vehicle 12 in step 305. Bend 10b typically prevents the longer leg of clip 10 from snagging on shade 16 when clip 10 is pressed down by the index finger. Bend 10b also helps to locate the longer leg of clip 10 on the inside of window 18 and shade 16. With the long leg of clip 10 so positioned in step 309, the thumb bends out the short leg of clip 10 by making use of bend 10a at the end of the short leg. At the same time, the longer leg of clip 10 presses against shade 16 and the inside of window 18, thereby locating (step 311) the short leg of clip 10 over a minor part of shade 16 located on the outside of vehicle 12/outside of window 18.

A downward pressure on the curvature 10c of clip 10 (step 313) using the index finger whilst bending out the short leg of clip 10 between the index finger and the thumb, allows clip 10 to be placed over the major part and the minor part of shade 16/window 18 as shown in FIG. 3b. Bend 10a prevents the shorter leg of clip 10 from snagging on shade 16 when clip 10 is pressed down by the index finger. Bend 10a also provides a point of frictional attachment of shade 16 to window 18 whilst a spring action of the long and the short legs of clip 10 provided by curvature 10c also clamps shade 16 to window 18. The point of frictional attachment and the spring action of clamp 10 is such that when window 18 is wound up and down, the clamping and/or frictional attachment of shade 16 to window 18 remains in place.

The term “consisting” as used herein, refers to a closed group of elements for example, consisting of an element A and an element B means including only one or more of element A and one or more of element B and no other elements other than element A and element B are included.

The term “comprising” as used herein, refers to an open group of elements for example, comprising an element A and an element B means including one or more of element A and one or more of element B and other elements other than element A and element B may be included.

The definite articles “a”, “an” is used herein, such as “a clip”, “a shade material” have the meaning of “one or more” that is “one or more clips or “one or more shade materials”, unless limited to a single item by such as by the term “consisting” as defined above.

Examples of various features/aspects/components/operations have been provided to facilitate understanding of the disclosed embodiments of the present invention. In addition, various preferences have been discussed to facilitate understanding of the disclosed embodiments of the present invention. It is to be understood that all examples and preferences disclosed herein are intended to be non-limiting.

Although selected embodiments of the present invention have been shown and described individually, it is to be understood that at least aspects of the described embodiments may be combined. Also although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

1. A system for shading a window of a motor vehicle, the system including:
a shade material, including a first portion adapted to cover an area of the window, a second portion adapted to be located outside the window and a bent portion adapted to be bent over an edge of the window; and
at least one clip with a first leg and a second leg, wherein said first leg and said second leg are adapted to press on said shade material to thereby provide a frictional attachment of said shade material to said window with said first leg and said second leg, wherein said window when partially opened does not disturb said frictional attachment of said shade material to said window.

2. (canceled)

3. The system of claim 1, wherein said first leg includes a bend in a direction away from the window when installed on the window.

4. The system of claim 1, wherein said at least one clip includes at least two clips.

5. The system of claim 1, wherein said at least one clip is one clip extended over a substantial portion of said edge of said window.

6. The system of claim 1, wherein said at least one clip is manufactured from spring steel.

7. A method for shading a window of a motor vehicle using a shade material and a clip, the method with the window partially open, the method including:
folding the shade material over an edge of the window;
locating a first portion of the shade material to be on the inside of the motor vehicle;
locating a second portion of the shade material to be on the outside of said motor vehicle;
positioning a first leg of the clip in vicinity of said first portion;
positioning a second leg of the clip in vicinity of said second portion; and
applying a downward pressure on said clip thereby providing a frictional clamping of the shade material to both the inside and outside of said window with said first leg and said second leg respectively;
winding up thereby raising the window to provide shade from the sun; and
winding down thereby lowering the window thereby removing the shade from the sun and fully viewing the environment exterior to the vehicle, wherein said winding down does not disturb said frictional clamping.

8. A kit for shading a window of a motor vehicle, the kit consisting of:
a shade material;
two clips each with a first leg and a second leg, whereby said first leg and said second leg are adapted to press on said shade material folded over the top edge of the window, wherein said clips provide a frictional attachment of said shade material to said window between said first leg and said second leg, wherein said window when partially opened does not disturb said frictional attachment of said shade material to said window between said first leg and said second leg.

9-11. (canceled)
